(19) United States
(12) Patent Application Publication
(10) Pub. No.: US 2026/0322792 A1
(43) Pub. Date: Oct. 15, 2026

(54) SUPPORTING ENCAPSULATION OF INTERNET PROTOCOL SECURITY ENCAPSULATING SECURITY PAYLOAD PACKETS IN USER DATAGRAM PROTOCOL HEADERS

(71) Applicant: Juniper Networks, Inc., Sunnyvale, CA (US)

(72) Inventors: Mahendra Maddur PUTTASWAMY, Bangalore (IN); Ranjan SINHA, Bangalore (IN); Naresh CHAND, Bangalore (IN)

(21) Appl. No.: 19/178,395

(22) Filed: Apr. 14, 2025

(51) Int. Cl. H04L 9/40

(52) U.S. Cl. CPC H04L 63/061; H04L 63/0435

(57) ABSTRACT

In some implementations, a first device may transmit a first indication that the first device supports encapsulation of internet protocol (IP) security (IPsec) encapsulating security payload (ESP) packets in user datagram protocol (UDP) headers. The first device may receive a second indication of whether a second device supports the encapsulation of IPsec ESP packets in UDP headers. The first device may communicate network traffic based on the second indication.

### BACKGROUND

A data center is a physical location that houses one or more hosts (e.g., servers). In some examples, a data center may include a gateway that can communicate with other gateways of other data centers.

### SUMMARY

Some implementations described herein relate to a method. The method may include transmitting, by a first device, a first indication that the first device supports encapsulation of internet protocol (IP) security (IPsec) encapsulating security payload (ESP) packets in user datagram protocol (UDP) headers. The method may include receiving, by the first device, a second indication of whether a second device supports the encapsulation of IPsec ESP packets in UDP headers. The method may include communicating, by the first device, network traffic based on the second indication.

Some implementations described herein relate to a first device. The first device may include one or more memories and one or more processors. The one or more processors may be configured to transmit a first indication that the first device supports encapsulation of IPsec ESP packets in UDP headers, wherein the first indication comprises an internet key exchange security association initial message. The one or more processors may be configured to receive a second indication of whether a second device supports the encapsulation of IPsec ESP packets in UDP headers. The one or more processors may be configured to communicate network traffic based on the second indication.

Some implementations described herein relate to a non-transitory computer-readable medium that stores a set of instructions. The set of instructions, when executed by one or more processors of a first device, may cause the first device to transmit a first indication that the first device supports encapsulation of IPsec ESP packets in UDP headers, wherein the first indication indicates a UDP destination port associated with the encapsulation of IPsec ESP packets in UDP headers. The set of instructions, when executed by one or more processors of the first device, may cause the first device to receive a second indication of whether a second device supports the encapsulation of IPsec ESP packets in UDP headers. The set of instructions, when executed by one or more processors of the first device, may cause the first device to communicate network traffic based on the second indication.

### BRIEF DESCRIPTION OF THE DRAWINGS

FIG. 1 is a diagram of an example implementation associated with signaling for support of encapsulation of IPsec ESP packets in UDP headers.

FIGS. 2A-2D are diagrams of example flows associated with negotiation of ESP-in-UDP encapsulation parameters.

FIG. 3 is a diagram of an example environment in which systems and/or methods described herein may be implemented.

FIG. 4 is a diagram of example components of a device associated with support of encapsulation of IPsec ESP packets in UDP headers.

FIG. 5 is a diagram of example components of a device associated with support of encapsulation of IPsec ESP packets in UDP headers.

FIG. 6 is a flowchart of an example process associated with supporting encapsulation of IPsec ESP packets in UDP headers.

### DETAILED DESCRIPTION

The following detailed description of example implementations refers to the accompanying drawings. The same reference numbers in different drawings may identify the same or similar elements.

IPsec is a suite of authentication and encryption protocols. One IPsec protocol is ESP, which provides origin authenticity using an ESP header. In some examples, data centers may use IPsec ESP to communicate with each other. For example, large data centers may include thousands of hosts, and the network traffic flowing between the large data centers will have over one million flows. However, ESP headers of network traffic generated by the data centers reduce entropy of the network traffic, causing the network traffic to bottleneck. This bottlenecking occurs because IPsec encrypts original layer 3 (L3) and layer 4 (L4) headers and encapsulates an entire packet in an IP header and an ESP header. Because the IP addresses of these headers are static tunnel endpoint IP addresses, the entropy is reduced such that single forwarding path selection occurs in the network between the data centers, and all network traffic between the data centers flows over a single IPsec channel (e.g., a single network path) established between gateways connecting the data centers. The ESP headers may prevent load balancing in the network between the data centers even if multiple paths exist between the gateways. Thus, IPsec ESP encapsulation may reduce the entropy of network traffic between data centers, leading to single forwarding path selection and preventing realization of target throughput levels.

Intermediate routers may avoid transmitting large amounts of data via a single IPsec tunnel by performing balanced forward path selection using L3 or L4 data that provides sufficient entropy for selecting forwarding paths. In some examples, a UDP header that indicates such L3 or L4 data may be appended after ESP encapsulation. For example, a packet with an IP header may be encapsulated in an ESP header, and then encapsulated in a UDP header. This approach may be referred to as ESP-in-UDP encapsulation. Encapsulating IPsec ESP traffic in a UDP header may enable intermediate routers to perform load balancing of the encapsulated IPsec ESP traffic, such as over equal cost multipath, link aggregation groups, or the like. In some examples, a source port of the UDP header may help to increase entropy and may be derived from an original IP header of a packet. For example, the source port may be generated using a hash function of the source IP address, destination IP address, protocol, source port, and destination port of the original IP header. The destination port of the UDP header may be configured, or the destination port may remain the same for all flows. In some examples, the UDP header may be in the range <1025 – 65536>. Destination port 4500, which may be used for network address translation, may not be used in the UDP header port. If the destination port of the UDP header is not configured, then destination port 4565 may be used as a default destination port of the UDP header.

Whether and how to perform UDP encapsulation may be local to a system (e.g., a gateway and/or a data center), and a peer (e.g., a peer gateway and/or a peer data center) may have no knowledge regarding whether or how the system is to perform UDP encapsulation. As a result, IPsec ESP traffic may be lost if the systems have mismatching configurations of ESP-in-UDP encapsulation. For example, if ESP-in-UDP encapsulation is enabled on the system and not the peer system, or if ESP-in-UDP encapsulation is enabled on both systems but different UDP destination ports are configured on the systems, then ESP-in-UDP encapsulation may fail. Generally, a network administrator can manually configure or check the configurations of both systems only if the systems are in the same administrative domain. Moreover, manually configuring or checking the configurations is error-prone. For example, UDP destination ports on different systems may be manually configured incorrectly, leading to a configuration mismatch between systems. Recovering from a mismatch may consume significant processing, memory, or network bandwidth resources due to retransmission of lost IPsec ESP traffic, detection and debugging of the configuration mismatch, or the like.

Some implementations described herein enable negotiation of an ESP-in-UDP encapsulation capability. For example, peer systems may negotiate one or more ESP-in-UDP encapsulation parameters, such as a UDP destination port. In some examples, the peers may negotiate the ESP-in-UDP encapsulation capability as part of internet key exchange (IKE) security association (SA) negotiations. In some examples, the peers may negotiate the ESP-in-UDP encapsulation capability using an IKE version 2 (IKEv2) protocol. In some aspects, a peer initiating an IKE SA creation may advertise a willingness to perform UDP encapsulation of ESP traffic using a notify payload. For example, the notify payload may have a message type indicating that the first device supports encapsulation of IPsec ESP packets in UDP headers (“ESP_IN_UDP_SUPPORTED”). A responding peer may decode the notify payload and, if the responding peer is also willing to perform ESP-in-UDP encapsulation, respond with the same type of notify payload; if the responding peer is not willing to perform ESP-in-UDP encapsulation, then the responding peer may ignore the notify payload. If the initiating peer does not receive a notify payload of the type ESP_IN_UDP_SUPPORTED from the responding peer, then the initiating peer may deduce that responding peer does not support or is not willing to perform ESP-in-UDP encapsulation. In some aspects, the initiating peer may proceed with creating the IKE SA and transmit ESP packets without UDP encapsulation. In some aspects, the initiating peer may tear down the IKE SA if the local policy mandates that the initiating peer is to communicate using ESP-in-UDP encapsulation.

As a result, negotiating the ESP-in-UDP encapsulation capability may help to ensure that the peers have matching configurations of ESP-in-UDP encapsulation. For example, the peers may determine whether both peers have ESP-in-UDP encapsulation enabled, establish the same UDP destination port for ESP-in-UDP encapsulation, or the like. The matching configurations may help to prevent lost IPsec ESP traffic regardless of whether the peers share the same administrative domain. For example, the peers may negotiate the ESP-in-UDP encapsulation capability across different administrative domains, which may help to improve interoperability. Additionally, or alternatively, negotiating the ESP-in-UDP encapsulation capability may help to reduce errors due to manual configuration or manual checking of configurations. Accordingly, negotiating the ESP-in-UDP encapsulation capability may help to reduce processing, memory, or network bandwidth resource consumption that would otherwise occur due to retransmission of lost IPsec ESP traffic, detection and debugging of the configuration mismatch, or the like.

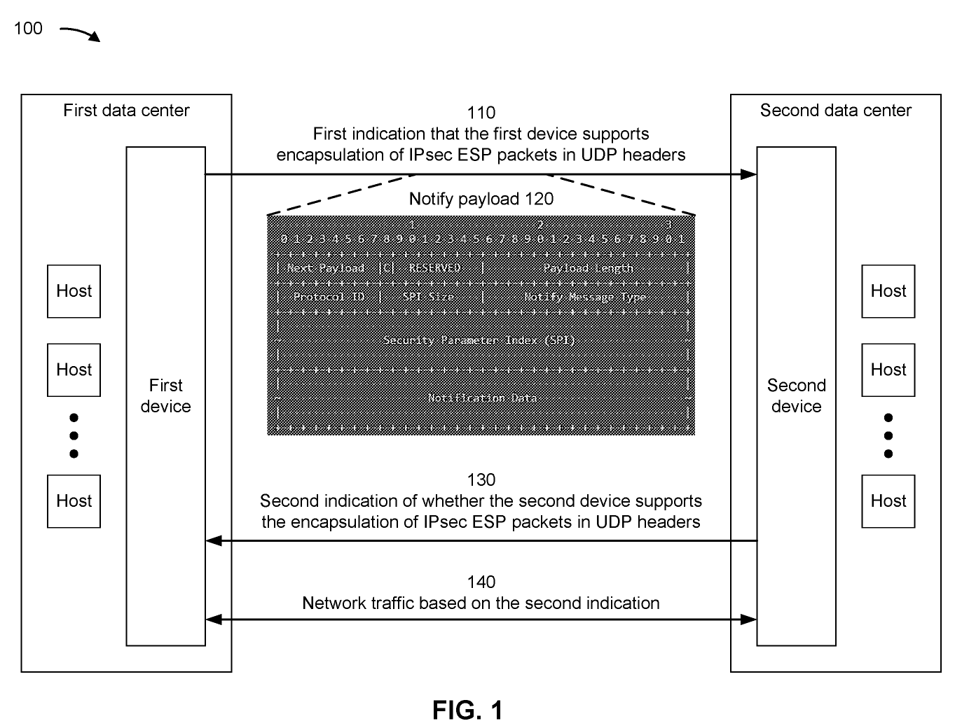

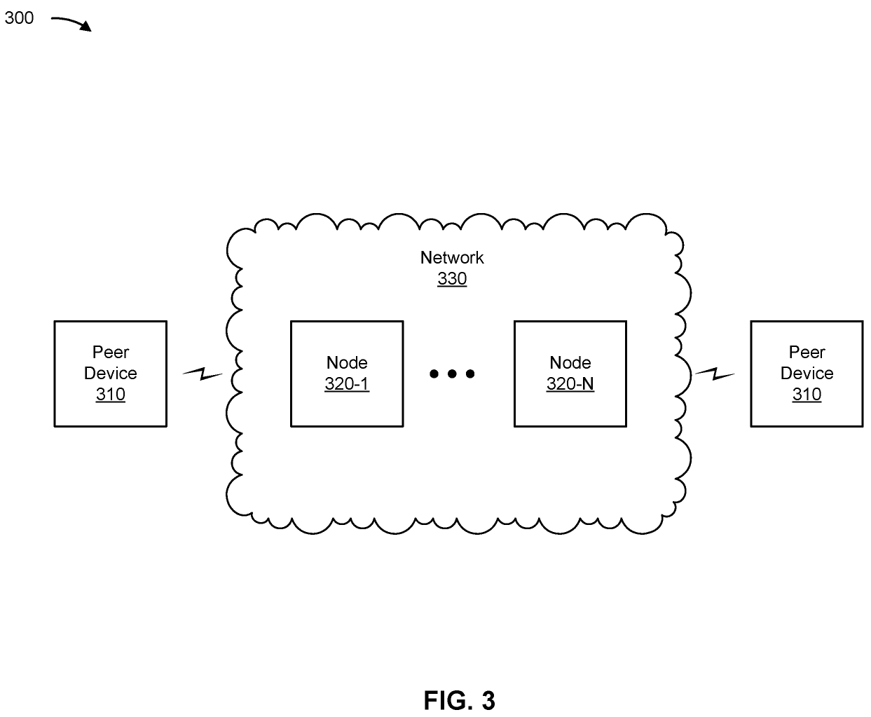

FIG. 1 is a diagram of an example implementation 100 associated with signaling for support of encapsulation of IPsec ESP packets in UDP headers. As shown in FIG. 1, example implementation 100 includes a first data center and a second data center. The first data center includes a first device (e.g., a first gateway) and a first plurality of hosts, and the second data center includes a second device (e.g., a second gateway) and a second plurality of hosts. The first and second devices are described in more detail below in connection with FIGS. 3-5.

As shown by reference number 110, the first device may transmit, and the second device may receive, a first indication that the first device supports encapsulation of IPsec ESP packets in UDP headers. The encapsulation of IPsec ESP packets in UDP headers (e.g., ESP-in-UDP encapsulation) may include appending of a UDP header to an IPsec ESP packet. In some examples, the first indication may advertise or publish a capability of the first device to perform encapsulation of IPsec ESP packets in UDP headers. In some examples, the first indication may indicate that the first device is configured, permitted, or otherwise prepared to perform encapsulation of IPsec ESP packets in UDP headers.

In some aspects, the first indication may include an IKE SA initial (IKE_SA_INIT) message. IKE is an IPsec protocol for establishing a security association between two network entities. An IKE_SA_INIT message may be a request to establish an SA, or a response to the request. In some examples, the first device, which transmits the first indication, may also initiate IKE SA creation (e.g., the IKE_SA_INIT message may be a request to establish an IKE SA).

In some aspects, the IKE_SA_INIT message may include a notify payload 120. As shown, the notify payload 120 may include various fields, such as a protocol identifier field, a security parameter index (SPI) size field, an SPI field, and a notification data field. The protocol identifier field may be set to 1, which may correspond to IKE. For initial IKE SA negotiation, the SPI size field and the SPI field may be set to 0. In some aspects, the first indication may include a notify message type of the notify payload 120. For example, the notify payload 120 may include a notify message type field that indicates the notify message type. In some examples, the notify message type field may be set to ESP_IN_UDP_SUPPORTED. Thus, the first indication may be provided via the notify payload 120 of the notify message type ESP_IN_UDP_SUPPORTED.

In some aspects, the first indication may indicate a UDP destination port associated with the encapsulation of IPsec ESP packets in UDP headers. The UDP destination port may be associated with the encapsulation of IPsec ESP packets in UDP headers in that the first device may attempt to perform the encapsulation of IPsec ESP packets in UDP headers using the UDP destination port. For example, the first indication may indicate a UDP destination port to be indicated in encapsulating UDP headers. In some examples, the UDP destination port may be indicated in the notification data field of the notify payload 120. For example, the notification data field may carry a UDP destination port number for the UDP destination port. In some aspects, the UDP destination port number may be 5656.

As shown by reference number 130, the second device may transmit, and the first device may receive, a second indication of whether the second device supports the encapsulation of IPsec ESP packets in UDP headers. For example, the second device may decode the first indication and, based on the first indication, respond with the second indication. In some examples, the second device supports the encapsulation of IPsec ESP packets in UDP headers. For example, the second indication may advertise or publish a capability of the second device to perform encapsulation of IPsec ESP packets in UDP headers, and/or the second indication may indicate that the second device is configured, permitted, or otherwise prepared to perform encapsulation of IPsec ESP packets in UDP headers. In some examples, the second indication may be another IKE_SA_INIT message (e.g., a response to the request to establish an IKE SA). Thus, in some examples, the first device and the second device may agree (via the first and second indications) to support and/or perform encapsulation of IPsec ESP packets in UDP headers during IKE SA creation. In some examples, the second indication may include a notify payload of the notify message type ESP_IN_UDP_SUPPORTED. In some examples, the second device does not support performing (e.g., is not capable of, configured to, permitted to, or otherwise prepared to perform) the encapsulation of IPsec ESP packets in UDP headers. For example, the second device may ignore the notify payload 120 and transmit an IKE_SA_INIT message without a notify payload of the notify message type ESP_IN_UDP_SUPPORTED.

As shown by reference number 140, the first device and the second device may communicate network traffic based on the second indication. In some examples, the first device may transmit, and the second device may receive, the network traffic. In some examples, the second device may transmit, and the first device may receive, the network traffic. If the first and second devices support the encapsulation of IPsec ESP packets in UDP headers, then the network traffic may include IPsec ESP packets encapsulated in UDP headers. If the first and second devices do not support the encapsulation of IPsec ESP packets in UDP headers, then the network traffic may include IPsec ESP packets that are not encapsulated in UDP headers or one or more control messages preventing creation of the IKE SA.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

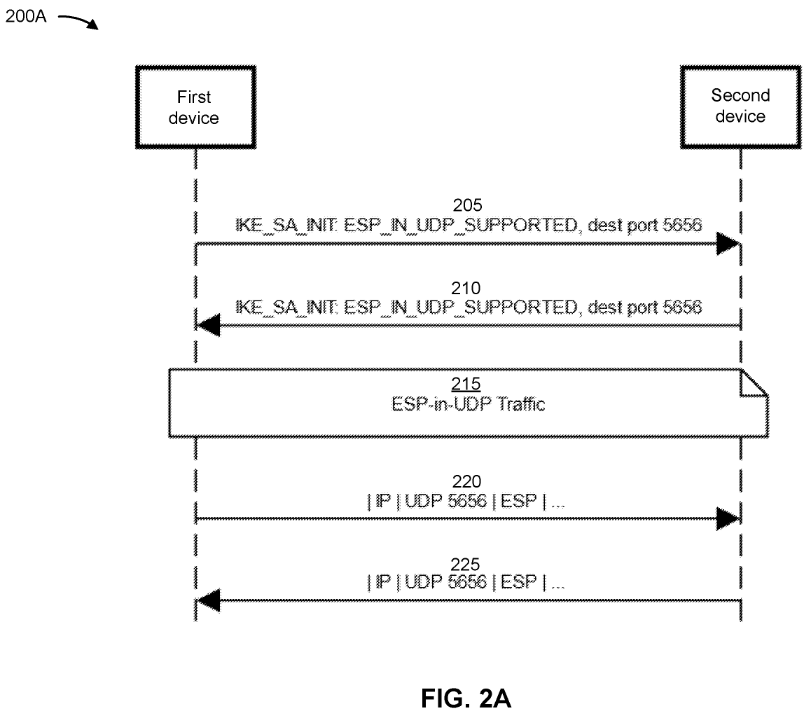

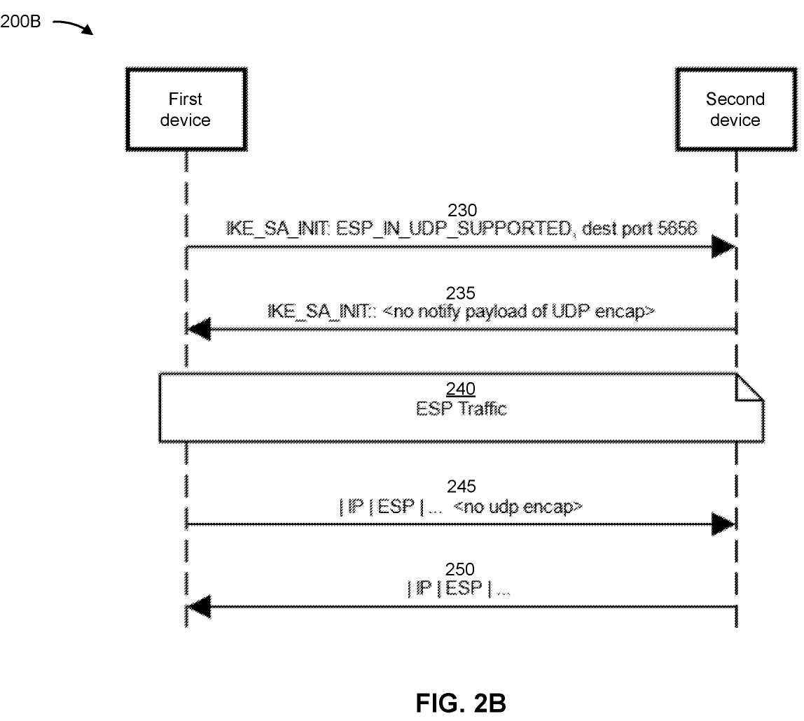

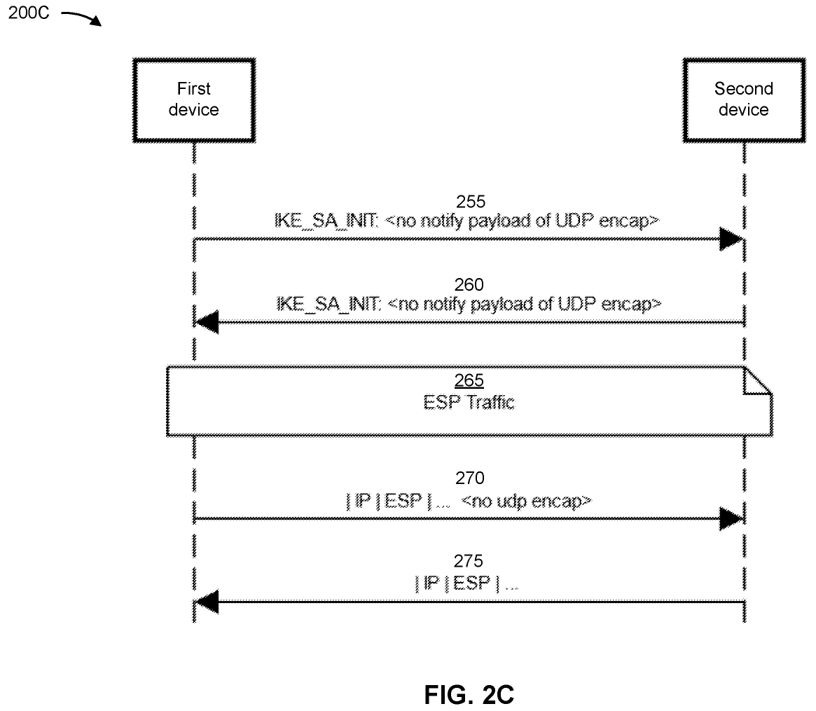

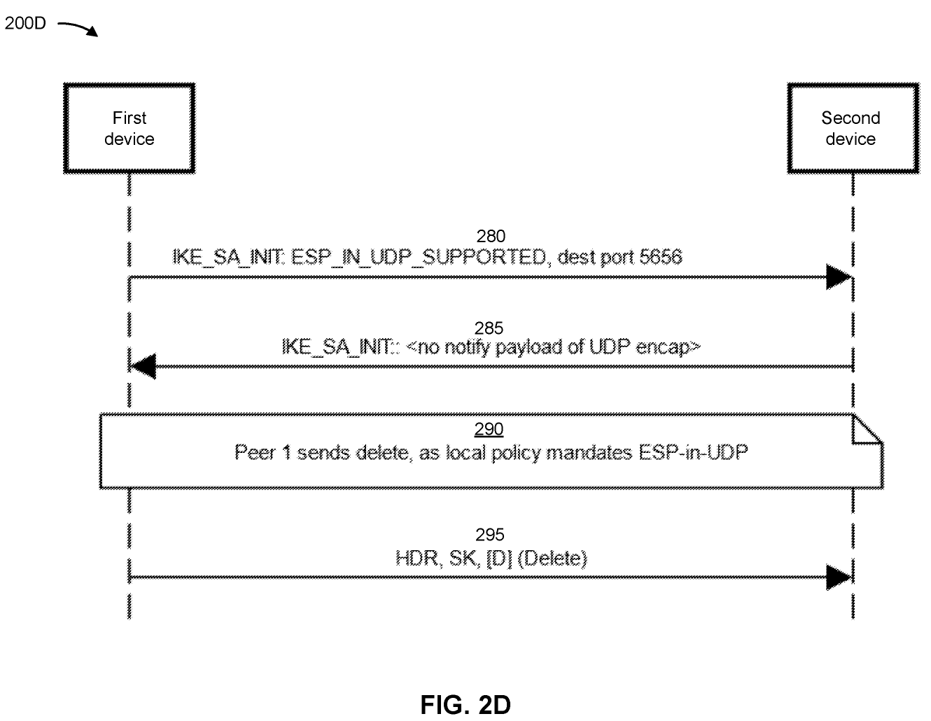

FIGS. 2A-2D are diagrams of example flows 200A-200D associated with negotiation of ESP-in-UDP encapsulation parameters in IKEv2.

Example flow 200A relates to successful negotiation of encapsulation of IPsec ESP packets in UDP headers. As shown by reference number 205, the first device may transmit, and the second device may receive, the first indication. The first indication may include the IKE_SA_INIT message. For example, the IKE_SA_INIT message may include a notify payload, such as the notify payload 120. For example, the notify payload 120 may include a notify message type field that indicates a notify message type of ESP_IN_UDP_SUPPORTED, and a notification data field indicating a UDP destination port number of 5656.

In some aspects, the second indication may indicate that the second device supports the encapsulation of IPsec ESP packets in UDP headers. For example, as shown by reference number 210, the second device may transmit, and the first device may receive, the second indication. The second indication may include an IKE_SA_INIT message. For example, the IKE_SA_INIT message may include a notify payload, such as the notify payload 120. For example, the notify payload 120 may include a notify message type field that indicates a notify message type of ESP_IN_UDP_SUPPORTED, and a notification data field indicating a UDP destination port number of 5656.

In some aspects, the network traffic may include one or more IPsec ESP packets encapsulated in one or more UDP headers. For example, as shown by reference number 215, the first device and the second device may communicate the IPsec ESP packets encapsulated in one or more UDP headers. For example, as shown by reference number 220, the first device may transmit, and the second device may receive, one or more IPsec ESP packets encapsulated in one or more UDP headers having a UDP destination port number of 5656. Additionally, or alternatively, shown by reference number 225, the second device may transmit, and the first device may receive, one or more IPsec ESP packets encapsulated in one or more UDP headers having a UDP destination port number of 5656.

Example flow 200B relates to unsuccessful negotiation of encapsulation of IPsec ESP packets in UDP headers because the second device does not support encapsulation of IPsec ESP packets in UDP headers. As shown by reference number 230, the first device may transmit, and the second device may receive, the first indication. The first indication may include the IKE_SA_INIT message. For example, the IKE_SA_INIT message may include a notify payload, such as the notify payload 120. For example, the notify payload 120 may include a notify message type field that indicates a notify message type of ESP_IN_UDP_SUPPORTED, and a notification data field indicating a UDP destination port number of 5656.

In some aspects, the second indication may indicate that the second device does not support the encapsulation of IPsec ESP packets in UDP headers. For example, as shown by reference number 235, the second device may transmit, and the first device may receive, the second indication. The second indication may include an IKE_SA_INIT message. For example, the IKE_SA_INIT message may not include a notify payload with a notify message type field that indicates a notify message type of ESP_IN_UDP_SUPPORTED. The first device may identify, based on the IKE_SA_INIT message, that the second device does not support ESP-in-UDP encapsulation. In example flow 200B, the first device may proceed with IKE negotiation for IPsec with ESP without UDP header encapsulation.

In some aspects, the network traffic may include one or more IPsec ESP packets that are not encapsulated in any UDP headers. For example, as shown by reference number 240, the first device and the second device may communicate the IPsec ESP packets without UDP header encapsulation. For example, as shown by reference number 245, the first device may transmit, and the second device may receive, one or more IPsec ESP packets that are not encapsulated in any UDP headers. Additionally, or alternatively, shown by reference number 250, the second device may transmit, and the first device may receive, one or more IPsec ESP packets that are not encapsulated in any UDP headers.

Example flow 200C relates to unsuccessful negotiation of encapsulation of IPsec ESP packets in UDP headers because the first device does not support encapsulation of IPsec ESP packets in UDP headers.

In some examples, the first indication may indicate that the first device does not support the encapsulation of IPsec ESP packets in UDP headers. For example, as shown by reference number 255, the first device may transmit, and the second device may receive, the first indication. The first indication may include an IKE_SA_INIT message. For example, the IKE_SA_INIT message may not include a notify payload with a notify message type field that indicates a notify message type of ESP_IN_UDP_SUPPORTED.

As shown by reference number 260, the second device may transmit, and the first device may receive, the second indication, which may indicate that the second device does not support the encapsulation of IPsec ESP packets in UDP headers. The second indication may include an IKE_SA_INIT message. For example, the IKE_SA_INIT message may not include a notify payload with a notify message type field that indicates a notify message type of ESP_IN_UDP_SUPPORTED.

The network traffic may include one or more IPsec ESP packets that are not encapsulated in any UDP headers. For example, as shown by reference number 265, the first device and the second device may communicate the IPsec ESP packets without UDP header encapsulation. For example, as shown by reference number 270, the first device may transmit, and the second device may receive, one or more IPsec ESP packets that are not encapsulated in any UDP headers. Additionally, or alternatively, shown by reference number 275, the second device may transmit, and the first device may receive, one or more IPsec ESP packets that are not encapsulated in any UDP headers.

Example flow 200D relates to unsuccessful negotiation of encapsulation of IPsec ESP packets in UDP headers due to a local policy of the first device that mandates ESP-in-UDP.

As shown by reference number 280, the first device may transmit, and the second device may receive, the first indication. The first indication may include the IKE_SA_INIT message. For example, the IKE_SA_INIT message may include a notify payload, such as the notify payload 120. For example, the notify payload 120 may include a notify message type field that indicates a notify message type of ESP_IN_UDP_SUPPORTED, and a notification data field indicating a UDP destination port number of 5656.

In some aspects, the second indication may indicate that the second device does not support the encapsulation of IPsec ESP packets in UDP headers. For example, as shown by reference number 285, the second device may transmit, and the first device may receive, the second indication, which may indicate that the second device does not support the encapsulation of IPsec ESP packets in UDP headers. The second indication may include an IKE_SA_INIT message. For example, the IKE_SA_INIT message may not include a notify payload with a notify message type field that indicates a notify message type of ESP_IN_UDP_SUPPORTED. The first device may identify, based on the IKE_SA_INIT message, that the second device does not support ESP-in-UDP encapsulation.

In some aspects, the network traffic may include a third indication to terminate a negotiation between the first device and the second device. The negotiation may be the IKE negotiation, such as an IKE SA negotiation. For example, as shown by reference number 290, the first device may decide to terminate (e.g., delete or tear down) the negotiation based on a local policy mandating that network traffic between the first device and the second device should include one or more IPsec ESP packets encapsulated in one or more UDP headers. As shown by reference number 295, the first device may transmit network traffic (e.g., a message) that includes an IKE header (HDR), an indication that the message carries an encrypted payload (SK), and the third indication.

As indicated above, FIGS. 2A-2D are provided as an example. Other examples may differ from what is described with regard to FIGS. 2A-2D.

The first indication that the first device supports the encapsulation of IPsec ESP packets in UDP headers and the second indication of whether the second device supports the encapsulation of IPsec ESP packets in UDP headers may help to ensure that the peers have matching configurations of ESP-in-UDP encapsulation. For example, the first and second devices may determine whether both devices have ESP-in-UDP encapsulation enabled, establish the same UDP destination port for ESP-in-UDP encapsulation, or the like. The matching configurations may help to prevent lost IPsec ESP traffic regardless of whether the devices share the same administrative domain. For example, the devices may negotiate the ESP-in-UDP encapsulation capability across different administrative domains, which may help to improve interoperability. Additionally, or alternatively, the first and second indications may help to reduce errors due to manual configuration or manual checking of configurations. Accordingly, the first and second indications may help to reduce processing, memory, or network bandwidth resource consumption that would otherwise occur due to retransmission of lost IPsec ESP traffic, detection and debugging of the configuration mismatch, or the like.

FIG. 3 is a diagram of an example environment 300 in which systems and/or methods described herein may be implemented. As shown in FIG. 3, environment 300 may include one or more peer devices 310, a group of nodes 320 (shown as node 320-1 through node 320-N), and a network 330. Devices of environment 300 may interconnect via wired connections, wireless connections, or a combination of wired and wireless connections.

Peer device 310 includes one or more devices capable of receiving and/or providing network traffic. For example, peer device 310 may include a traffic transfer device, such as a router, a gateway, a switch, a firewall, a hub, a bridge, a reverse proxy, a server (e.g., a proxy server, a server executing a virtual machine, etc.), a security device, an intrusion detection device, a load balancer, or a similar type of device. In some implementations, peer device 310 may include an endpoint device that is a source or a destination for network traffic. For example, peer device 310 may include a computer or a similar type of device. Peer device 310 may receive network traffic from and/or may provide network traffic (e.g., payload packets) to other peer devices 310 via network 330 (e.g., by routing payload packets using node(s) 320 as an intermediary). In some implementations, peer device 310 may include an edge device that is located at an edge of one or more networks. For example, peer device 310 receive network traffic from and/or may provide network traffic (e.g., payload packets) to devices external to network 330.

Node 320 includes one or more devices capable of receiving, processing, storing, routing, and/or providing traffic (e.g., a payload packet, a file, etc.) in a manner described herein. For example, node 320 may include a router, such as a label switching router (LSR), a label edge router (LER), an ingress router, an egress router, a provider router (e.g., a provider edge router, a provider core router, etc.), a virtual router, or another type of router. Additionally, or alternatively, node 320 may include a gateway, a switch, a firewall, a hub, a bridge, a reverse proxy, a server (e.g., a proxy server, a cloud server, a data center server, etc.), a load balancer, and/or a similar device.

In some implementations, node 320 may be a physical device implemented within a housing, such as a chassis. In some implementations, node 320 may be a virtual device implemented by one or more computer devices of a cloud computing environment or a data center.

In some implementations, node 320 may be configured with one or more segment translation tables. In some implementations, node 320 may receive a payload packet from peer device 310. In some implementations, node 320 may encapsulate the payload packet using a compressed routing header (CRH) and may route the IP payload packet to another node 320, using one or more techniques described elsewhere herein. In some implementations, node 320 may be an edge node in network 330. In some implementations, node 320 may be an intermediary node in network 330 (i.e., a node between two or more edge nodes).

Network 330 includes one or more wired and/or wireless networks. For example, network 330 may include a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 3 are provided as one or more examples. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

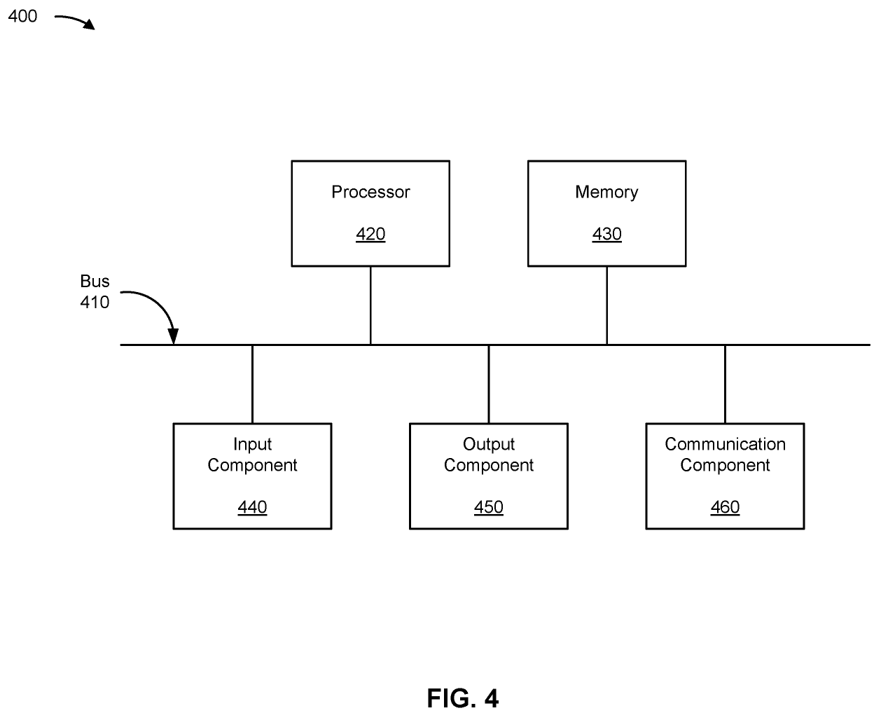

FIG. 4 is a diagram of example components of a device 400 associated with support of encapsulation of IPsec ESP packets in UDP headers. The device 400 corresponds to one or more of peer device 310 and/or node 320. In some implementations, peer device 310 and/or node 320 include one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

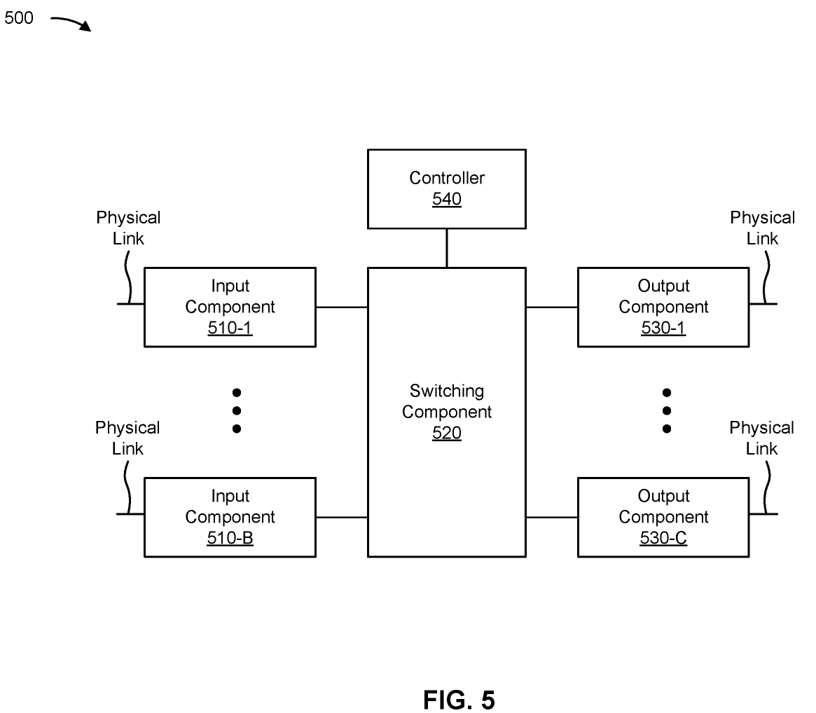

FIG. 5 is a diagram of example components of a device 500 associated with support of encapsulation of IPsec ESP packets in UDP headers. Device 500 may correspond to peer device 310 and/or node 320. In some implementations, peer device 310 and/or node 320 may include one or more devices 500 and/or one or more components of device 500. As shown in FIG. 5, device 500 may include one or more input components 510-1 through 510-B (B ≥ 1) (hereinafter referred to collectively as input components 510, and individually as input component 510), a switching component 520, one or more output components 530-1 through 530-C (C ≥ 1) (hereinafter referred to collectively as output components 530, and individually as output component 530), and a controller 540.

Input component 510 may be one or more points of attachment for physical links and may be one or more points of entry for incoming traffic, such as packets. Input component 510 may process incoming traffic, such as by performing data link layer encapsulation or decapsulation. In some implementations, input component 510 may transmit and/or receive packets. In some implementations, input component 510 may include an input line card that includes one or more packet processing components (e.g., in the form of integrated circuits), such as one or more interface cards (IFCs), packet forwarding components, line card controller components, input ports, processors, memories, and/or input queues. In some implementations, device 500 may include one or more input components 510.

Switching component 520 may interconnect input components 510 with output components 530. In some implementations, switching component 520 may be implemented via one or more crossbars, via busses, and/or with shared memories. The shared memories may act as temporary buffers to store packets from input components 510 before the packets are eventually scheduled for delivery to output components 530. In some implementations, switching component 520 may enable input components 510, output components 530, and/or controller 540 to communicate with one another.

Output component 530 may store packets and may schedule packets for transmission on output physical links. Output component 530 may support data link layer encapsulation or decapsulation, and/or a variety of higher-level protocols. In some implementations, output component 530 may transmit packets and/or receive packets. In some implementations, output component 530 may include an output line card that includes one or more packet processing components (e.g., in the form of integrated circuits), such as one or more IFCs, packet forwarding components, line card controller components, output ports, processors, memories, and/or output queues. In some implementations, device 500 may include one or more output components 530. In some implementations, input component 510 and output component 530 may be implemented by the same set of components (e.g., and input/output component may be a combination of input component 510 and output component 530).

Controller 540 includes a processor in the form of, for example, a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processor. The processor is implemented in hardware, firmware, or a combination of hardware and software. In some implementations, controller 540 may include one or more processors that can be programmed to perform a function.

In some implementations, controller 540 may include a RAM, a ROM, and/or another type of dynamic or static storage device (e.g., a flash memory, a magnetic memory, an optical memory, etc.) that stores information and/or instructions for use by controller 540.

In some implementations, controller 540 may communicate with other devices, networks, and/or systems connected to device 500 to exchange information regarding network topology. Controller 540 may create routing tables based on the network topology information, may create forwarding tables based on the routing tables, and may forward the forwarding tables to input components 510 and/or output components 530. Input components 510 and/or output components 530 may use the forwarding tables to perform route lookups for incoming and/or outgoing packets.

Controller 540 may perform one or more processes described herein. Controller 540 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with controller 540 from another computer-readable medium or from another device via a communication interface. When executed, software instructions stored in a memory and/or storage component associated with controller 540 may cause controller 540 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

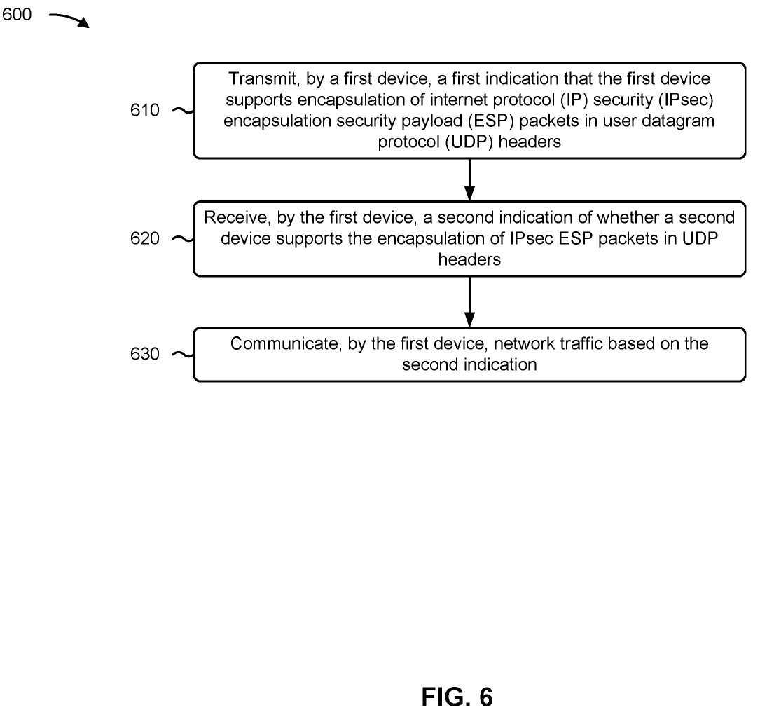

FIG. 6 is a flowchart of an example process 600 associated with supporting encapsulation of IPsec ESP packets in UDP headers. One or more process blocks of FIG. 6 are performed by a first device (e.g., the first device shown in FIGS. 1 or 2A-2D) and/or by another device or a group of devices separate from or including the first device, such as a peer device (e.g., peer device 310) and/or a node (e.g., node 320). Additionally, or alternatively, one or more process blocks of FIG. 6 may be performed by one or more components of device 400, such as processor 420, memory 430, input component 440, output component 450, and/or communication component 460. Additionally, or alternatively, one or more process blocks of FIG. 6 may be performed by one or more components of device 500, such as input component 510, switching component 520, output component 530, and/or controller 540.

As shown in FIG. 6, process 600 includes transmitting a first indication that the first device supports encapsulation of IPsec ESP packets in UDP headers (block 610). For example, the first device may transmit a first indication that the first device supports encapsulation of IPsec ESP packets in UDP headers, as described above.

As further shown in FIG. 6, process 600 includes receiving a second indication of whether a second device supports the encapsulation of IPsec ESP packets in UDP headers (block 620). For example, the first device may receive a second indication of whether a second device supports the encapsulation of IPsec ESP packets in UDP headers, as described above.

As further shown in FIG. 6, process 600 includes communicating network traffic based on the second indication (block 630). For example, the first device may communicate network traffic based on the second indication, as described above.

Process 600 may include additional aspects, such as any single aspect or any combination of aspects described below and/or in connection with one or more other processes described elsewhere herein.

In a first aspect, the first indication comprises an internet key exchange security association initial message.

In a second aspect, alone or in combination with the first aspect, the internet key exchange security association initial message includes a notify payload, and the first indication comprises a notify message type of the notify payload.

In a third aspect, alone or in combination with one or more of the first and second aspects, the first indication indicates a UDP destination port associated with the encapsulation of IPsec ESP packets in UDP headers.

In a fourth aspect, alone or in combination with one or more of the first through third aspects, a UDP destination port number of the UDP destination port is 5656.

In a fifth aspect, alone or in combination with one or more of the first through fourth aspects, the second indication indicates that the second device supports the encapsulation of IPsec ESP packets in UDP headers, and the network traffic includes one or more IPsec ESP packets encapsulated in one or more UDP headers.

In a sixth aspect, alone or in combination with one or more of the first through fifth aspects, the second indication indicates that the second device does not support the encapsulation of IPsec ESP packets in UDP headers, and the network traffic includes one or more IPsec ESP packets that are not encapsulated in any UDP headers.

In a seventh aspect, alone or in combination with one or more of the first through sixth aspects, the second indication indicates that the second device does not support the encapsulation of IPsec ESP packets in UDP headers, and the network traffic includes a third indication to terminate a negotiation between the first device and the second device.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, traffic or content may include a set of packets. A packet may refer to a communication structure for communicating information, such as a protocol data unit (PDU), a service data unit (SDU), a network packet, a datagram, a segment, a message, a block, a frame (e.g., an Ethernet frame), a portion of any of the above, and/or another type of formatted or unformatted unit of data capable of being transmitted via a network.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors to: perform X; perform Y; and perform Z,” that claim should be interpreted to mean “one or more processors to perform X; one or more (possibly different) processors to perform Y; and one or more (also possibly different) processors to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
transmitting, by a first device, a first indication that the first device supports encapsulation of internet protocol (IP) security (IPsec) encapsulating security payload (ESP) packets in user datagram protocol (UDP) headers;
receiving, by the first device, a second indication of whether a second device supports the encapsulation of IPsec ESP packets in UDP headers; and
communicating, by the first device, network traffic based on the second indication.

2. The method of claim 1, wherein the first indication comprises an internet key exchange security association initial message.

3. The method of claim 2, wherein the internet key exchange security association initial message includes a notify payload, and the first indication comprises a notify message type of the notify payload.

4. The method of claim 1, wherein the first indication indicates a UDP destination port associated with the encapsulation of IPsec ESP packets in UDP headers.

5. The method of claim 4, wherein a UDP destination port number of the UDP destination port is 5656.

6. The method of claim 1, wherein the second indication indicates that the second device supports the encapsulation of IPsec ESP packets in UDP headers, and the network traffic includes one or more IPsec ESP packets encapsulated in one or more UDP headers.

7. The method of claim 1, wherein the second indication indicates that the second device does not support the encapsulation of IPsec ESP packets in UDP headers, and the network traffic includes one or more IPsec ESP packets that are not encapsulated in any UDP headers.

8. The method of claim 1, wherein the second indication indicates that the second device does not support the encapsulation of IPsec ESP packets in UDP headers, and the network traffic includes a third indication to terminate a negotiation between the first device and the second device.

9. A first device, comprising:
one or more memories; and
one or more processors to:
transmit a first indication that the first device supports encapsulation of internet protocol (IP) security (IPsec) encapsulating security payload (ESP) packets in user datagram protocol (UDP) headers, wherein the first indication comprises an internet key exchange security association initial message;
receive a second indication of whether a second device supports the encapsulation of IPsec ESP packets in UDP headers; and
communicate network traffic based on the second indication.

10. The first device of claim 9, wherein the internet key exchange security association initial message includes a notify payload, and the first indication comprises a notify message type of the notify payload.

11. The first device of claim 9, wherein the first indication indicates a UDP destination port associated with the encapsulation of IPsec ESP packets in UDP headers.

12. The first device of claim 9, wherein the second indication indicates that the second device supports the encapsulation of IPsec ESP packets in UDP headers, and the network traffic includes one or more IPsec ESP packets encapsulated in one or more UDP headers.

13. The first device of claim 9, wherein the second indication indicates that the second device does not support the encapsulation of IPsec ESP packets in UDP headers, and the network traffic includes one or more IPsec ESP packets that are not encapsulated in any UDP headers.

14. The first device of claim 9, wherein the second indication indicates that the second device does not support the encapsulation of IPsec ESP packets in UDP headers, and the network traffic includes a third indication to terminate a negotiation between the first device and the second device.

15. A non-transitory computer-readable medium storing a set of instructions, the set of instructions comprising:
one or more instructions that, when executed by one or more processors of a first device, cause the first device to:
transmit a first indication that the first device supports encapsulation of internet protocol (IP) security (IPsec) encapsulating security payload (ESP) packets in user datagram protocol (UDP) headers, wherein the first indication indicates a UDP destination port associated with the encapsulation of IPsec ESP packets in UDP headers;
receive a second indication of whether a second device supports the encapsulation of IPsec ESP packets in UDP headers; and
communicate network traffic based on the second indication.

16. The non-transitory computer-readable medium of claim 15, wherein the first indication comprises an internet key exchange security association initial message.

17. The non-transitory computer-readable medium of claim 16, wherein the internet key exchange security association initial message includes a notify payload, and the first indication comprises a notify message type of the notify payload.

18. The non-transitory computer-readable medium of claim 15, wherein the second indication indicates that the second device supports the encapsulation of IPsec ESP packets in UDP headers, and the network traffic includes one or more IPsec ESP packets encapsulated in one or more UDP headers.

19. The non-transitory computer-readable medium of claim 15, wherein the second indication indicates that the second device does not support the encapsulation of IPsec ESP packets in UDP headers, and the network traffic includes one or more IPsec ESP packets that are not encapsulated in any UDP headers.

20. The non-transitory computer-readable medium of claim 15, wherein the second indication indicates that the second device does not support the encapsulation of IPsec ESP packets in UDP headers, and the network traffic includes a third indication to terminate a negotiation between the first device and the second device.
